(19) United States
(12) Patent Application Publication
(10) Pub. No.: US 2004/0104693 A1
(43) Pub. Date: Jun. 3, 2004

(54) Deflection yoke for cathode ray tube

(76) Inventors: Hyung Dal Joo, Dacjeon-si (KR); Woo Young Yang, Gyeongsangbeok-do (KR)

Correspondence Address: BIRCH STEWART KOLASCH & BIRCH, PO BOX 747, FALLS CHURCH, VA, 22040-0747, US

(21) Appl. No.: 10/715,527

(22) Filed: Nov. 19, 2003

(30) Foreign Application Priority Data
Nov. 19, 2002 (KR) 71952/2002
Jan. 9, 2003 (KR) 1425/2003

(51) Int. Cl. H01J 29/70

(52) U.S. Cl. 315/399; 315/370

(57) ABSTRACT

A deflection yoke for a cathode ray tube, with reduced weight and volume plus a low cost of manufacture is obtained by making a ferrite core housed in the deflection yoke very light and thin, based on an optimized design obtained through a number of experimental trials.

This nonprovisional application claims priority under 35 U.S.C. § 119(a) on Patent Application No. 71952/2002 filed in Korea on Nov. 19, 2002, and Patent Application No. 1425/2003 filed in Korea on Jan. 9, 2003, which are herein incorporated by reference.

### BACKGROUND OF THE INVENTION

1. Field of the Invention

The present invention relates to a deflection yoke for a cathode ray tube, and more particularly, to a deflection yoke for a cathode ray tube having less weight and volume and a low cost of manufacture, by making a ferrite core housed in the deflection yoke very light and thin, based on an optimized design obtained through a number of experimental trials.

2. Discussion of the Background Art

FIG. 1 is a diagram explaining the structure of a color cathode ray tube of the background art.

The color cathode ray tube has a fluorescent screen on a front surface of a cone-shaped vacuum tube, and there is an electron gun and a deflection yoke in a neck portion on the opposite side of the screen, whereby electron beams emitted from the electron gun are deflected and collided with the fluorescent screen to display an image.

As depicted in FIG. 1, a panel 1 and a funnel 2 of the color cathode ray tube are sealed up tightly together, so the inside of the cathode ray tube 11 is generally in a vacuum state.

The fluorescent screen 12 containing fluorescent substances (or phosphors) is placed inside of the funnel, and the electron gun 13 is housed in the neck portion of the funnel on the opposite side of the screen 12.

A shadow mask 14 for selecting colors is disposed at a predetermined space between the fluorescent screen 12 and the electron gun 13, more specifically, closer to the fluorescent screen3. Also, a deflection yoke 15 for deflecting electron beams emitted from the electron gun 13 is placed in the neck portion of the funnel.

To briefly explain how the color cathode ray tube with the above construction operates, the electron beams 16 emitted from the electron gun 13 are deflected in the horizontal and vertical directions by the deflection yoke 15, and the horizontally/vertically deflected electron beams 16 pass through a beam passing hole on the shadow mask 14 and eventually strike the fluorescent screen 12 on the front side, thereby displaying a desired image.

FIG. 2 depicts a more detailed construction of the deflection yoke.

Referring to FIG. 2, the deflection yoke 15 of the Background Art consists of a horizontal deflection coil 21 and a vertical deflection coil 22 for deflecting electron beams emitted from the electron guns in the horizontal or vertical direction, a ferrite core 24 for minimizing a loss in a magnetic force generated by the horizontal and vertical deflection coils 21 and 22 on its return path, a holder 23 for supporting the horizontal and vertical deflection coils 21 and 22 and ensuring the insulation between the horizontal and vertical deflection coils 21 and 22, cancel coils 25a and 25b disposed on the top and bottom ends of the screen side of the holder 23, to cancel a magnetic field leakage generated in the screen and neck portion of the deflection yoke 15, and a board 27 for connecting the cancel coils 25a and 25b to the horizontal deflection coil 21 using fetch lines 26a and 26b with the help of a terminal that connects the fetch lines to the horizontal deflection coil 21 and a correction circuit that guides the electron beams to arrive at a predetermined position on the screen.

In general, a deflection yoke 4 allows a current having a frequency of 15.75 KHz or above to travel to the vertical deflection coil 41, and using the magnetic field generated around the coil, deflects the electron beams 16 inside of the cathode ray tube in the horizontal direction.

Also, the deflection yoke 4 allows a current having a frequency of 60 Hz to travel to the vertical deflection coil 42, and using the magnetic field generated around the coil, deflects electron beams inside of the cathode ray tube in the vertical direction.

Therefore, an image gets displayed on the screen as the deflection yoke 15 deflects the electron beams 16 in the horizontal and vertical directions and converges them to a point on the screen.

One of currently developed deflection yokes is a self-convergence type deflection yoke, which uses the non-uniform magnetic fields around the horizontal and vertical deflection coils 21, 22 in order to get R, G and B three electron beams 16 to be converged on the screen without using a separate additional circuit or device.

In other words, by adjusting the turning distribution of the horizontal and vertical deflection coils 21 and 22, the self-convergence type deflection yoke creates a barrel or pin-cushion shaped magnetic field for each section (i.e., opening portion, middle portion, neck portion), and allows each of those three electron beams 16 to experience a different deflecting force depending on their positions (yet to be converged upon one point from different distances) although each electron beam starts and ends in a different position from one another.

Here, the screen portion of the deflection yoke indicates a portion adjacent to the screen having a relatively large diameter cross-section, and the neck portion indicates a portion having a relatively small diameter cross-section on the opposite side of the screen portion.

The middle portion, as the name implies, indicates a middle portion of the screen portion and the neck portion.

The above definitions will be equally applied to the screen portion, the neck portion, the end of the screen side, and the end of the neck side for the deflection yoke, the deflection coils, the holder and the ferrite core, respectively.

Meanwhile, one of typical problems cathode ray tube manufacturers are faced with is that it is actually very difficult to deflect the electron beams 16 onto the full screen if they use only the magnetic fields generated around the horizontal and vertical deflection coils 21 and 22 by flowing the horizontally and vertically deflected currents into the coils. Hence, the ferrite core 24 with a high magnetic permeability is usually employed to minimize the loss in the magnetic fields generated by the horizontal and vertical deflection coils 21 and 22 on its return path, and further to improve a magnetic efficiency and magnetic force.

However, it is observed that the screen portion and the neck portion of the deflection yoke often generate not only the deflection magnetic fields for deflecting the electron beams in the horizontal and vertically directions but also an unnecessary magnetic field leakage that is very harmful to a human body.

Hence, a means for reducing the magnetic field leakage at the deflection yoke for the cathode ray tube is required.

More specifically, it is important to keep the magnetic leakage generated around the cathode ray tube under a predetermined level. Considering that an extremely-low-frequency (ELF) band ranging from 5 Hz to 2 kHz and a very-low-frequency (VLF) band ranging from 2 kHz to 400 kHz are very harmful to a human body, the means for reducing the magnetic field leakage is absolutely necessary.

Although some manufacturers have tried to increase the radius and the tilt angle of the screen portion of the deflection yoke to obtain a high deflection angle and ultimately to reduce the total length of the cathode ray tube, this only gave rise to an enormous increase in the magnetic field leakage.

As aforementioned, a great deal of research has been focused on how to reduce the total length of the cathode ray tube. To this end, one should develop a technique for obtaining a high deflection angle. In doing so, however, it is observed that as the deflection angle is increased, the radius and the tilt angle of the screen portion of the deflection yoke increased also. As a consequence, much more magnetic field leakage was generated at the horizontal deflection coil.

As another way to reduce the magnetic field leakage, one could install the cancel coils 25a and 25b at the top and bottom of the screen of the holder 23, or increase the distance from the end of the screen side of the ferrite core 24 to the end of the screen side of the horizontal deflection coil.

For instance, FIG. 2 illustrates the structure of the deflection yoke, in which the cancel coils 25a and 25b are attached to the top and bottom of the screen portion of the holder 23.

Technically speaking, the magnetic field generated by the pair of cancel coils 25a and 25b attached to the top and bottom of the screen portion of the holder 23 cancels the magnetic field leakage.

The cancel coils 25a and 25b are connected to the horizontal deflection coil in such a manner that the magnetic field leakage generated at the screen portion of the horizontal deflection coil 21 is opposite to the main deflection magnetic field generated at the horizontally deflected current traveling in the cancel coils 25a and 25b, thereby canceling the magnetic field leakage generated at the screen portion and the neck portion of the deflection yoke 15.

As discussed before, in case of generating the magnetic fields by providing a current to the horizontal and vertical deflection coils 21 and 22 for a purpose of deflecting the electron beams 16 to the full screen, the magnetic fields generated in this manner are not sufficient to accomplish the purpose. Hence, the ferrite core 24 with a high magnetic permeability is employed to minimize the loss in the magnetic fields generated by the horizontal and vertical deflection coils 21 and 22 on its return path, and further to improve a magnetic efficiency and magnetic force.

In general, the ferrite core 24 that has a high magnetic permeability basically contains ferric oxide (Fe₂O₃) and other additives (e.g. Mn, Mg etc).

The shape of the ferrite core 24 used for cathode ray tube products is mostly circular, but a rectangular-shaped ferrite core is also used in order to enhance the efficiency.

In FIG. 3, (a) depicts the circular ferrite core 31 and (b) depicts the rectangular-shaped ferrite core 32.

Actually, the thickness of the ferrite core and the position of its placement are important matters for consideration in connection with the sensitivity of the deflection yoke and the magnetic field leakage, so special attention should be given to designing of an appropriate ferrite core to manufacture high quality deflection yoke.

As described before, the ferrite core 24 is very effective for canceling the magnetic field, whereby the deflection efficiency of the deflection yoke is improved and the magnetic field leakage is reduced. For these reasons, the ferrite core 24 often looks like a closed loop encompassing the deflection yoke.

To effectuate the described goals, the ferrite core 24 should have a high magnetic permeability (μ) (e.g. higher than 300) and a high electric resistance for minimizing any loss due to an Eddy current.

Despite all of the above efforts, the ferrite core of the deflection yoke for the cathode ray tube according to the background art still has problems associated with cost, weight, volume, and quality.

For instance, the circular/cone shaped ferrite core used in most deflection yokes is as thick as 6 mm or more, and a diagonal corner of the ferrite core is as thick as 8 mm or more.

However, if the ferrite core gets thicker than a predetermined level, the excess part (i.e. the thickness greater than the predetermined one) yields only marginal benefit.

In short, since the ferrite core of the background art was designed thicker than necessary, the cost of manufacture was high, although it should not have been and the thick ferrite core made the deflection yoke very heavy and bulky. Further, the quality of the deflection yoke was degraded and more money than necessary in the form of shipping charges was spent.

### SUMMARY OF THE INVENTION

An object of the invention is to solve at least the above problems and/or disadvantages and to provide at least the advantages described hereinafter.

Accordingly, one object of the present invention is to solve the foregoing problems by providing a deflection yoke for a cathode ray tube with less weight and volume by substantially reducing the weight and volume of a known ferrite core without any degradation in its properties.

Another object of the present invention is to provide a deflection yoke for a cathode ray tube with reduced manufacturing costs, volume, weight and shipping charges, by conducting a number of experiments to produce a ferrite core having an optimized thickness and weight with no degradation in its deflection capacity.

Another object of the invention is to provide a deflection yoke for a cathode ray tube, consisting of a horizontal deflection coil, a vertical deflection coil, a holder for supporting the horizontal and vertical deflection coils and insulating them at the same time, a ferrite core for reducing a leakage flux, having a much reduced weight and volume yet with properties equivalent to a larger core, and a means for solving any possible structural problem caused by a thin ferrite core.

The foregoing and other objects and advantages are realized by providing a cathode ray tube mounted with a panel, a funnel, a electron gun for emitting electron beams, and a deflection yoke for deflecting the electron beams emitted from the electron gun, the deflection yoke including a horizontal deflection coil for deflecting the electron beams in the horizontal direction, a vertical deflection coil for deflecting the electron beams in the vertical direction, a holder for supporting, and at the same time insulating the horizontal and vertical deflection coils, and a ferrite core for reducing a leakage flux on a return path of magnetic fields generated by the horizontal and vertical deflection coils, where a thickness of the ferrite core is less than 6 mm and given that a maximum thickness point and a minimum thickness point exists in the ferrite core, the maximum thickness point of the ferrite core is not less than 3 mm.

Another aspect of the invention provides a cathode ray tube mounted with a panel, a funnel, a electron gun for emitting electron beams, and a deflection yoke for deflecting the electron beams emitted from the electron gun, the deflection yoke including a horizontal deflection coil for deflecting the electron beams in the horizontal direction, a vertical deflection coil for deflecting the electron beams in the vertical direction, a holder for supporting and at the same time insulating the horizontal and vertical deflection coils, and a ferrite core for reducing a leakage flux on a return path of magnetic fields generated by the horizontal and vertical deflection coils, where a thickness of the ferrite core is less than 6 mm and a maximum thickness point and a minimum thickness point exist in the ferrite core and the maximum thickness point of the ferrite core is located between a end of a neck side of the ferrite core and ½ Lf, given Lf is a length of the ferrite core.

Still another aspect of the invention provides a cathode ray tube mounted with a panel, a funnel, a electron gun for emitting electron beams, and a deflection yoke for deflecting the electron beams emitted from the electron gun, the deflection yoke including a horizontal deflection coil for deflecting the electron beams in the horizontal direction, a vertical deflection coil for deflecting the electron beams in the vertical direction, a holder for supporting and at the same time insulating the horizontal and vertical deflection coils, and a ferrite core for reducing a leakage flux on a return path of magnetic fields generated by the horizontal and vertical deflection coils, where the funnel has a yoke placement portion on which the yoke is mounted, and a cross-section of an inner surface of the yoke placement portion or a cross-section for both inner and outer surfaces of the yoke placement portion gradually changes from a circular shape to a non-circular shape approaching a screen side from a neck side, and a maximum thickness point of the ferrite core ranges from 3 mm to 6 mm in thickness.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic diagram illustrating a cathode ray tube of the background art;

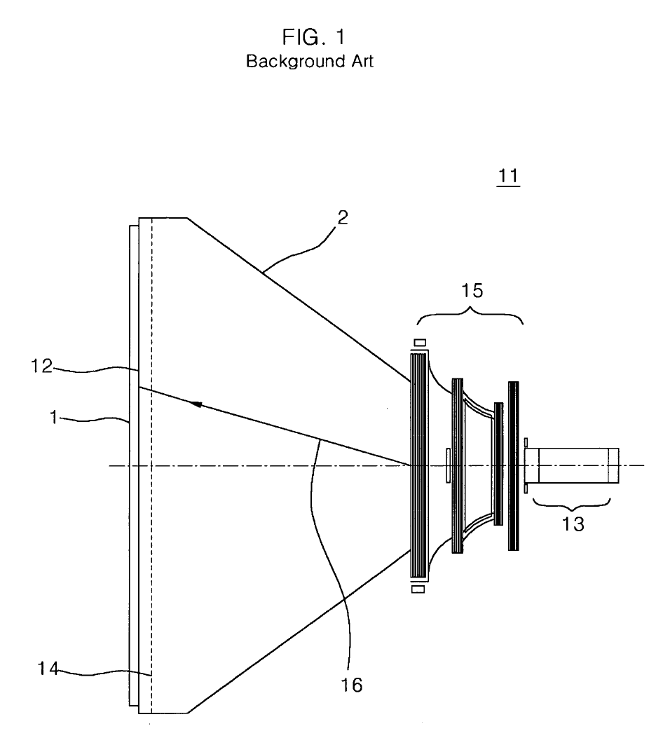

FIG. 2 is a perspective view of a deflection yoke for a cathode ray tube;

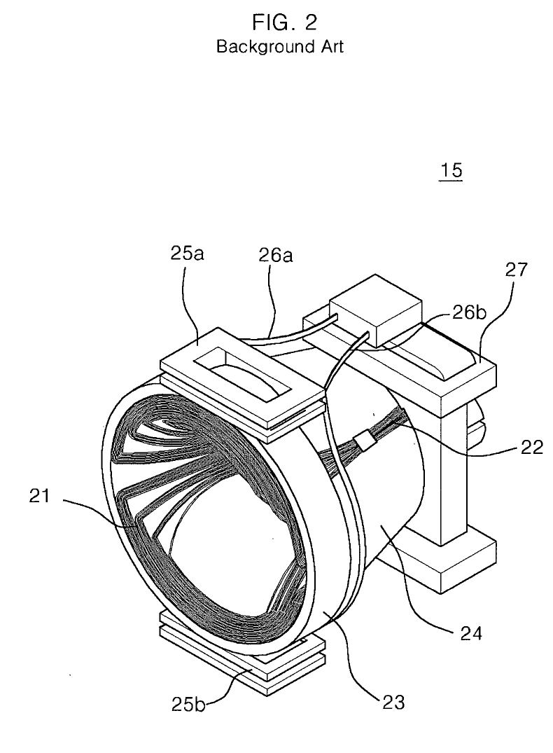

FIG. 3 depicts structures of a circular ferrite core and a rectangular-shaped ferrite core;

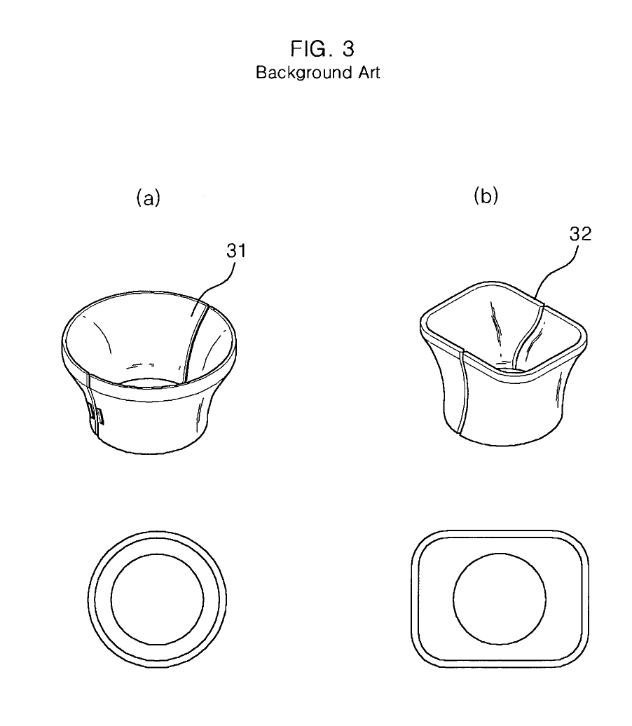

FIG. 4 diagrammatically explains relative positions of a horizontal deflection coil and a ferrite core, and represents a calculation background of the thickness of the core according to the present invention;

FIG. 5 is a cross-sectional view of the thickness of a ferrite core according to the present invention;

FIG. 6 is a perspective view of the thickness of an end of a neck side of the ferrite core and an inside diameter of the ferrite core;

FIG. 7 shows schematic diagrams illustrating the thickness of the end of the neck side and inside diameter of the ferrite core for an approximately circular core and a circular core, respectively; and

FIG. 8 is a schematic diagram illustrating the thickness at a ⅓ point of a length of the ferrite core starting from an end of a screen side of the ferrite core, and the thickness of the end of the neck side of the ferrite core according to the present invention.

### DETAILED DESCRIPTION OF PREFERRED EMBODIMENT

The following detailed description will present a deflection yoke for a cathode ray tube according to a preferred embodiment of the invention in reference to the accompanying drawings.

Generally, a vertical inductance value for vertical deflection decreases as a ferrite core gets thinner, and if a current is applied, the screen size is slightly reduced. However, this problem can be easily solved by making copper wires in the conventional deflection coil thinner and increasing the number of turns of the coil, while not necessarily increasing the sensitivity of the deflection coil and increasing the expense of manufacture.

This highlights the need for development of a technique for reducing the thickness of the ferrite core.

The main reason why cathode ray tube manufacturers did not mind using such thick ferrite cores was that the cost of manufacture for the ferrite core was negligible when compared to the typically enormous cost of manufacture for the deflection yoke.

However, many now recognize that allow cost is a driving force of competitors in the cathode ray tube market. From this aspect, it is a very crucial matter to be able to get rid of unnecessary costs of manufacture and to develop a cathode ray tube with reduced weight and volume by making a thin core while simplifying issues of transportation or handling of the product.

Normally, it is believed that the cost of manufacture can be reduced by 10% per weight of the ferrite core, and this results in a 5% price cut for each ferrite core. However, if the ferrite core of the present invention is used, the weight of the ferrite core can be reduced by 30% or more.

If the ferrite core is made thin, it becomes possible to reduce the magnetic field leakage generated at the deflection yoke (especially, a horizontal deflection coil).

In other words, if one uses a thinner ferrite core than the conventional one, he can also reduce the turn number of cancel coils for reducing the magnetic field leakage (VLMF) and thus reduce the cost of manufacture proportionately.

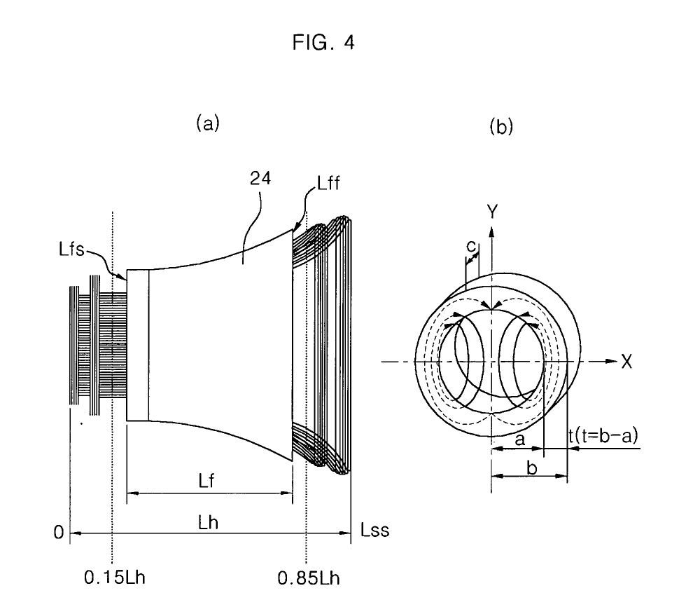

In FIG. 4, (a) is a schematic diagram showing the relation positions of the horizontal deflection coil and the ferrite core.

In the drawing, Lh indicates the length of the horizontal deflection coil from O to an end of the screen side Lss and O indicates the position of the end of the neck side of the horizontal deflection coil. Lf indicates the length from the position (Lfs) of the end of the neck side of the ferrite core 24 to the position (Lff) of the end of the screen side of the ferrite core 24.

To make the ferrite core 24 thin, the ratio of Lh to Lf should be optimized as well. To make a conclusion first based on an experiment (this will be described later) conducted, Lf is in range of from 0.1 Lh to 0.9 Lh, and Lf is preferably not less than 35 mm and not greater than 55 mm.

Particularly, (b) of FIG. 4 illustrates a theoretical background for calculating the thickness of the thin ferrite core according to the present invention.

As explained before, the primary objective of the present invention is to design a ferrite core with a minimum thickness. To this end, the employed method therefor is to determine the thickness in accordance with the amount of magnetic flux inside of the ferrite core.

Suppose that the inside diameter of the ferrite core is 2a, the outside diameter of the ferrite core is 2b, and the length from the neck side (straight line) of the ferrite core to the end is c. Then, magnetic flux (φin) carried into the ferrite core region from the coils inside the ferrite core and saturated magnetic flux density (Bm) of the ferrite core are in a relation of φin≦φm. (Here, φm=c(b−a)Bm; the highest magnetic flux density of the ferrite core.)

Since (b−a) in the equation corresponds the thickness, t, of the core, one can rewrite the equation as t≧[(φin)/(Bm∘c)].

Therefore, an optimized thickness for the ferrite core can be obtained on the basis of the relation among the thickness of the ferrite core, the magnetic flux, and the length of the neck side of the ferrite core.

In the present invention, for instance, a 6.8 mm-thick ferrite core in a 17″ monitor, the most widely used monitor was selected for an experiment for obtaining an optimized thickness for the ferrite core. For the experiment, the ferrite core was modified in many ways and checked for a better result.

Usually, the deflection yoke for a TV and the deflection yoke for a monitor have an almost identical magnetic field inside the deflection yoke, provided a deflection angle of each cathode ray tube is the same.

Of course, the methods for adjusting (or changing) the intensity of the magnetic field are different from each other. However, from the aspect of the magnetic field only, the magnitude of the magnetic field generated by the coils in one of the devices is not that different from the other, and if the ferrite cores having the magnetic field have the same structure and position with each other, they will do the same work. The basic issue is whether or not the ferrite cores have the same intensity of the magnetic field.

In short, although the experiment for the present invention only used the ferrite core for the monitor deflection yoke, the ferrite core for the TV deflection yoke can also be used.

Also, there is a yoke placement portion on which the yoke is mounted, and a cross-section of an inner surface of the yoke placement portion or a cross-section for both inner and outer surfaces of the yoke placement portion gradually changing from a circular shape to a non-circular shape approaching a screen side from a neck side, or it might as well remain circular.

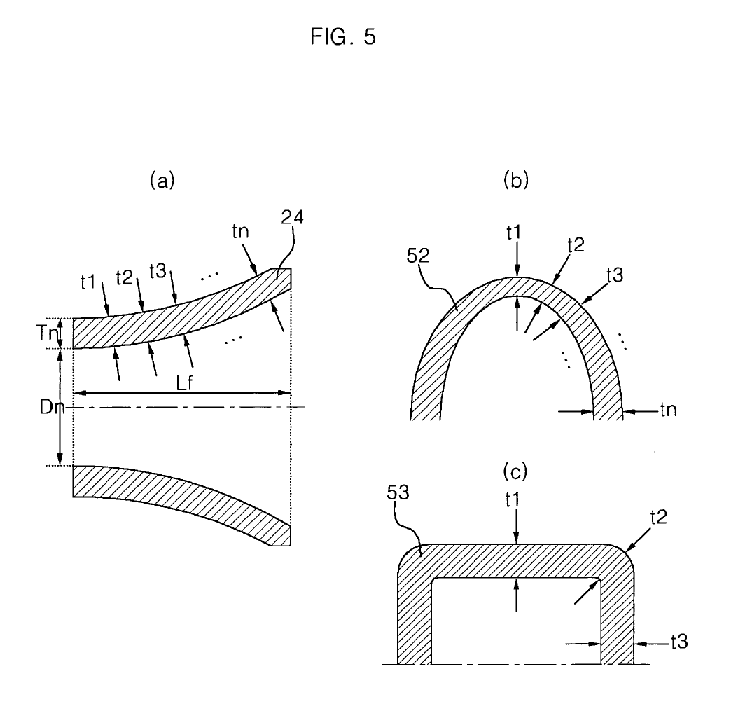

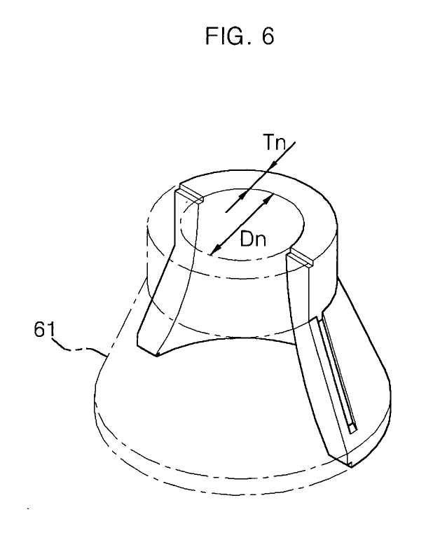

FIG. 5 is a cross-sectional view of the thickness of the ferrite core according to the present invention, and FIG. 6 is a perspective view of the thickness of the end of the neck side and inside diameter of the ferrite core.

In FIG. 5, (a) illustrates the thickness, Tn, at the end of the neck side of the ferrite core 24, the thicknesses, t1, t2, t3, . . . , tn, towards the screen side, the length, Lf, of the ferrite core, and the diameter, Dn, of the end of the neck side of the ferrite core.

The diagram in (b) illustrates the cross-section of the circular ferrite core 52 and its thicknesses, t1, t2, t3, . . . , tn; and (c) illustrates the cross section of the rectangular shaped ferrite core 53 and its thicknesses, t1, t2, t3, . . . , tn.

FIG. 6 is a perspective view of the circular ferrite core, and the definitions made for ‘Tn’ and ‘Dn’ in (a) of FIG. 5 are again applied here.

As mentioned before, the conventional 6.8 mm-thick ferrite core was used and its thickness was gradually reduced by 0.5 mm for each observation. This process was continued until the thickness of the ferrite core became 3.5 mm thinner than the original sample.

More specifically, a total of 8 samples were prepared, and the thickness of the ferrite core ranged from 6.8 mm down to 3.3 mm. Each sample was then subjected to a variety of tests involving magnetic properties, influences on the screen and reliability (exothermic characteristics).

TABLE 1

| Thickness | 6.8 mm | 6.3 mm | 5.8 mm | 5.3 mm | 4.8 mm | 4.3 mm | 3.8 mm | 3.3 mm |
|---|---|---|---|---|---|---|---|---|
| Inductance(mH) | 0.136 | 0.136 | 0.135 | 0.135 | 0.135 | 0.135 | 0.135 | 0.134 |

Table 1 shows how the inductance value of the horizontal deflection coil changes in accordance with the thickness of the ferrite core.

As shown in Table 1, the inductance value of the horizontal deflection coil in accordance with the different thicknesses of the ferrite core was rarely changed, and it only showed 0.002 mH of reduction (approximately 1% reduction) of the horizontal deflection inductance when the thickness of the ferrite core was reduced by 3.5 mm.

According to another observation, provided the same normal ferrite core and the same current were used, the screen size remained almost constant despite the different thicknesses, and the change in the convergence was negligible.

From the experiment results so far, one can conclude that except for the reliability factor (i.e. exothermic characteristics), there is little difference between the conventional 6.8 mm-thick ferrite core and the 3.3 mm-thick ferrite core.

As for the exothermic characteristics, it was observed that the surface temperature of the ferrite core was increased as the thickness of the ferrite core decreased, but the temperature inside the coil remained constant.

Of course, the temperature was the highest at the inside of the coil (i.e. 100° C.), and the next was the ferrite core (80° C.-100° C.), and the atmospheric temperature was the lowest.

It would be a serious problem if the ferrite core characteristics were degraded as its temperature is raised. Fortunately though, the Curie temperature of the conventional ferrite core is higher than 130° C., and the magnetic permeability of the ferrite core tended to get better up to the Curie temperature. Hence, this problem can be treated as negligible as well.

In case of the vertical deflection coil, since it is located closer to the ferrite core, the inductance was slightly reduced in accordance with the thickness of the core.

TABLE 2

| Thickness | 6.8 mm | 6.3 mm | 5.8 mm | 5.3 mm | 4.8 mm | 4.3 mm | 3.8 mm | 3.3 mm |
|---|---|---|---|---|---|---|---|---|
| Inductance(mH) | 6.335 | 6.300 | 6.313 | 6.306 | 6.254 | 6.237 | 3.210 | 6.065 |

Table 2 shows how the inductance value of the vertical deflection coil changes in accordance with the thickness of the ferrite core.

As shown in Table 2, when the thickness of the normal ferrite core was reduced from 6.8 mm to 3.3 mm, the inductance of the vertical deflection coil was reduced by 0.27 mH (approximately 4% reduction).

Also, the vertical deflection size of the electron beams was reduced.

Again, the 4% inductance reduction of the vertical deflection coil due to the decrease in the thickness of the ferrite core can be easily corrected by increasing the number of turns of the vertical deflection coil (normally 100 turns) by 4-6 turns. In this manner, the deflection coil can do its usual job, namely deflecting the electron beams, without causing a power loss or bringing substantial structural modification to the coil.

In case that the thickness of the ferrite core was reduced by 3 mm, such as from 6.8 mm to 3.8 mm, only a small amount of the inductance of the vertical deflection coil was reduced, such as from 6.335 mH to 6.210 mH, showing not more than about 2% reduction. Moreover, when the thickness of the ferrite core was reduced by 3.5 mm, the screen size was reduced even far more than that, demanding much less correction thereon.

Again, no critical change was observed in the convergence according to the vertical deflection despite the reduced thickness of the ferrite core.

To summarize, in case of the horizontal deflection coil, the thickness of the ferrite core can be reduced by 50% or more of the original thickness (i.e. 7 mm), and in case of the vertical deflection coil, an appropriate thickness for the ferrite core can be decided based on the amount of correction of the vertical deflection.

Assuming that there is nothing wrong with the existing vertical deflection and the appropriate thickness of the ferrite core is 5% of the vertical inductance, then a preferable minimum thickness of the ferrite core can be cut down to 3.0 mm.

With this thin ferrite core plus some technical aid (relevant to the number of turns of coils and the coil's thickness), it is possible to manufacture the ferrite core with a much less cost while maintaining essential properties of the ferrite core.

According to the experimental results shown in Table 1 and Table 2 and the analyses thereon, a desired maximum thickness point of the ferrite core of the present invention ranges from 3 mm to 6 mm.

In addition, the length of the thin ferrite core, Lf, according to the present invention should be in range of 0.1 Lh to 0.9 Lh, in order to bring no degradation in the properties of the ferrite core and yield the same effects as before.

More preferably, the maximum thickness point of the ferrite core ranges from 4 mm to 6 mm.

Even more preferably, if one wishes to minimize the cost of manufacture without changing the properties of the ferrite core itself, the maximum thickness point of the ferrite core ranges from 4 mm to 5.5 mm.

Also, the thickness, Tn, of the end of the neck side of the thin ferrite core is not greater than 5 mm and not smaller than 4 mm.

This type of the ferrite core can be widely used, whether its shape from the end of the neck side to the end of the screen side is all circular or whether the cross-section of the end of the neck side is circular or rectangular or whether the cross-section of the end of the screen side of the ferrite core is rectangular.

In the latter case, the maximum thickness point is preferably in a range of 3 mm to 6 mm.

Also, the principles of the present invention are applied to the divisional type ferrite core.

As for the ferrite core whose cross section of the end of the screen side is rectangular, the length, Lf, of the ferrite core is in range of 0.1 Lh to 0.9 Lh, where Lh is the length of the horizontal deflection coil. More specifically, Lf is not larger than 55 mm and not smaller than 35 mm.

Particularly for the ferrite core whose cross section of the end of the screen side is rectangular, it is more preferable to have the maximum thickness point in a range of 4 mm to 6 mm.

Even more preferably, if one wishes to minimize the cost of manufacture without changing the properties of the ferrite core itself, the maximum thickness point of the ferrite core ranges from 4 mm to 5.5 mm.

In a ferrite core having a cross-section of the end of the screen side, the maximum of the thickness, Tn, of the end of the neck side of the ferrite core is preferably not larger than 5 mm and not smaller than 4 mm.

The ferrite core of the present invention can be applied to TVs as well as computer monitors. As for TVs, the maximum horizontal frequency is under 48 kHz, and as for monitors, the maximum horizontal frequency is under 80 kHz.

Usually, saddle/saddle type deflection coils are used for monitors (the former corresponds to the horizontal deflection coil and the latter corresponds to the vertical deflection coil, and the ‘saddle type’ indicates the shape of the coil), and saddle/saddle type or saddle/toroidal type coils are used for TVs (the former corresponds to the horizontal deflection coil and the latter corresponds to the vertical deflection coil, and the ‘toroidal type’ means that the ferrite core is directly wound with the coils).

Regardless of the type, the thin ferrite core of the present invention can be used. This is because the thickness of the ferrite core does not need to be dramatically changed as long as the magnitude of the internal magnetic field does not vary excessively.

Therefore, when the thin ferrite core of the present invention is applied to monitors and TVs, each type will demonstrate different characteristics of the ferrite core. Part of those characteristics has already been discussed before, and some other characteristics will now be described.

In most cases, the end of the neck side of the ferrite core is very thick, compared to the total thickness. This is because the temperature at the end of the neck side of the ferrite core is higher than at the other parts, meaning it should have a proportionately better radiative characteristic.

Hence, when the thin ferrite core of the present invention is employed, the thickness of the end of the neck side should be about 4 mm-5 mm, and it should be at least 80% of the maximum thickness.

According to an observation, when the end of the neck side is the thickest or thinner than 80% of the maximum thickness, the radiative characteristic of the ferrite core is degraded. Thus, it is important to keep the thickness of the end of the neck side at least 80% of the maximum thickness point of the ferrite core.

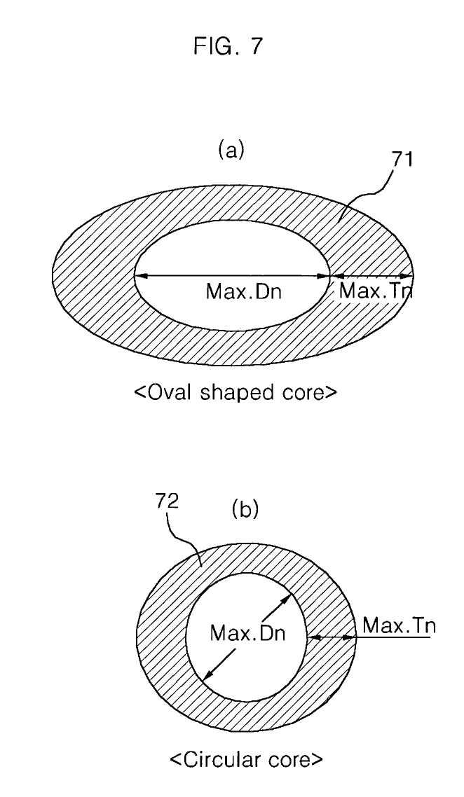

In FIG. 7, (a) depicts the ferrite core 71 which is not completely circular, and (b) depicts the ferrite core 72 which is completely circular.

Referring to the drawing, ‘Max.Dn’ indicates the maximum of the inside diameter, Dn, of the end of the neck side of the ferrite core, and ‘Max.Tn’ indicates the maximum of the thickness, Tn, of the end of the neck side of the ferrite core. These two variables are important factors for designing the thin ferrite core of the present invention without losing the properties and advantages of the thin ferrite core.

Preferably, the ratio of the maximum thickness of the ferrite core to the maximum thickness of the end of the neck side is not greater than 1.2 and not less than 1.0 for the both types of the ferrite core (circular and oval) shown in FIG. 7.

In addition, suppose that the maximum inside diameter of the end of the neck side for the deflection yoke for monitors is Max.Dn. Then, the ratio of the maximum inside diameter, Max.Dn, of the end of the neck side to the maximum thickness of the ferrite core is not greater than 10.5 and not less than 7.0. As for the deflection yoke for TVs, on the other hand, the ratio is not larger than 12.5 and not smaller than 9.0.

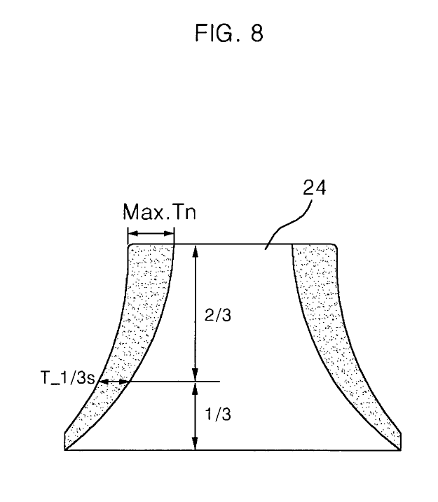

FIG. 8 is a schematic diagram illustrating the thickness at a ⅓ point of a length of the ferrite core starting from the end of the screen side of the ferrite core, and the thickness of the end of the neck side of the ferrite core. As described before, the drawing represents the relationship between the thickness at the ⅓ point (T_{—}⅓s) from the end of the screen side to the neck side of the optimally thin ferrite core 24 and the maximum thickness, Max.Tn, of the end of the neck side.

Whether the cross-section of the end of the screen side is circular or oval, the ratio of the thickness at the ⅓ point from the end of the screen side to the neck side of the ferrite core to the maximum thickness, Max.Tn, of the end of the neck side is not greater than 1.0 and not less than 0.8.

In conclusion, the present invention is mainly focused on making a thin and light ferrite core based on the optimized design. The ferrite core of the present invention is very advantageous in that one can reduce the cost of manufacture by getting rid of an unnecessary part of the thick ferrite core without losing the ferrite core's own characteristics.

Overall, the weight and volume of the deflection yoke can be greatly reduced by using the thin ferrite core of the present invention. Further, it contributes to the lightness of the cathode ray tube. As such, shipping charges can be reduced and handling the cathode ray tube becomes much easier.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A deflection yoke for a cathode ray tube mounted with a panel, a funnel, an electron gun for emitting electron beams, and a deflection yoke for deflecting the electron beams emitted from the electron gun, the deflection yoke comprising:
a horizontal deflection coil for deflecting the electron beams in the horizontal direction;
a vertical deflection coil for deflecting the electron beams in the vertical direction;
a holder for supporting and at the same time insulating the horizontal and vertical deflection coils; and
a ferrite core for reducing a leakage flux on a return path of magnetic fields generated by the horizontal and vertical deflection coils, where a thickness of the ferrite core is less than 6 mm, and given that maximum and minimum thickness points exist in the ferrite core, the maximum thickness point of the ferrite core is not less than 3 mm.

2. The deflection yoke according to claim 1, wherein a thickness at the minimum thickness point of the ferrite core is not less than 2 mm.

3. The deflection yoke according to claim 1, wherein a thickness at the maximum thickness point of the ferrite core ranges from 4 mm to 6 mm.

4. The deflection yoke according to claim 1, wherein when a length of the horizontal deflection coil from an end of a neck side to an end of a screen side is Lh, and a length of the ferrite core from an end of a neck side to an end of a screen side is Lf, the end of the neck side of the ferrite core to the end of the screen side of the ferrite core lies within a range from 0.1 Lh to 0.9 Lh of the horizontal deflection coil.

5. The deflection yoke according to claim 1, wherein a length, designated by Lf, of the ferrite core between an end of a neck side and an end of a screen side is not greater than 55 mm and not less than 35 mm.

6. The deflection yoke according to claim 1, wherein a cross-section of the ferrite core is circular or oval.

7. The deflection yoke according to claim 1, wherein a thickness of an end of a neck side of the ferrite core is not greater than 5 mm and not less than 4 mm.

8. The deflection yoke according to claim 1, wherein a ratio of the maximum thickness of the ferrite core to the maximum thickness of an end of a neck side of the ferrite core is not greater than 1.2 and not less than 1.0.

9. The deflection yoke according to claim 1, wherein a ratio of a thickness at a ⅓ point of the length of the ferrite core starting from an end of a screen side of the ferrite core to the maximum thickness of an end of a neck side of the ferrite core is not greater than 1.0 and not less than 0.8.

10. The deflection yoke according to claim 1, wherein the ferrite core is a divisional ferrite core.

11. The deflection yoke according to claim 1, wherein the cathode ray tube to which the deflection yoke is applied is a monitor.

12. The deflection yoke according to claim 11, wherein a ratio of a maximum inside diameter of an end of a neck side of the ferrite core to the maximum thickness of the ferrite core is not greater than 10.5 and not less than 7.0.

13. The deflection yoke according to claim 1, wherein the cathode ray tube to which the deflection yoke is applied is a color television.

14. The deflection yoke according to claim 13, wherein a ratio of a maximum inside diameter of an end of a neck side of the ferrite core to the maximum thickness of the ferrite core is not greater than 12.5 and not less than 9.0.

15. The deflection yoke according to claim 1, wherein the maximum thickness point of the ferrite core exists between an end of a neck side of the ferrite core and ½ Lf, where Lf is the length of the ferrite core.

16. The deflection yoke according to claim 15, wherein a thickness at the maximum thickness point of the ferrite core is not greater than 5.5 mm and not less than 4 mm.

17. The deflection yoke according to claim 1, wherein the horizontal deflection coil is a saddle deflection coil.

18. The deflection yoke according to claim 1, wherein the vertical deflection coil is a saddle deflection coil.

19. The deflection yoke according to claim 1, wherein the vertical deflection coil is a toroidal deflection coil.

20. A deflection yoke for a cathode ray tube mounted with a panel, a funnel, an electron gun for emitting electron beams, and a deflection yoke for deflecting the electron beams emitted from the electron gun, the deflection yoke comprising:
a horizontal deflection coil for deflecting the electron beams in the horizontal direction, a vertical deflection coil for deflecting the electron beams in the vertical direction;
a holder for supporting and at the same time insulating the horizontal and vertical deflection coils; and
a ferrite core for reducing a leakage flux on a return path of magnetic fields generated by the horizontal and vertical deflection coils, where a thickness of the ferrite core is less than 6 mm and maximum and minimum thickness points exist in the ferrite core and the maximum thickness point of the ferrite core is located between a end of a neck side of the ferrite core and ½ Lf, wherein Lf is a length of the ferrite core.

21. The deflection yoke according to claim 20, wherein a thickness at the minimum thickness point of the ferrite core is not less than 2 mm.

22. The deflection yoke according to claim 20, wherein a thickness at the maximum thickness point of the ferrite core ranges from 4 mm to 6 mm.

23. The deflection yoke according to claim 20, wherein when a length of the horizontal deflection coil from an end of the neck side to an end of a screen side is Lh, and a length of the ferrite core from an end of a neck side to an end of the screen side is Lf, the end of the neck side of the ferrite core to the end of the screen side of the ferrite core lies within a range from 0.1 Lh to 0.9 Lh of the horizontal deflection coil.

24. The deflection yoke according to claim 20, wherein the length of the ferrite core between the end of the neck side and an end of a screen side is not greater than 55 mm and not less than 35 mm.

25. The deflection yoke according to claim 20, wherein a cross-section of the ferrite core is circular or oval.

26. The deflection yoke according to claim 20, wherein a thickness of the end of the neck side of the ferrite core is not greater than 5 mm and not less than 4 mm.

27. The deflection yoke according to claim 20, wherein a ratio of the maximum thickness of the ferrite core to the maximum thickness of the end of the neck side of the ferrite core is not greater than 1.2 and not less than 1.0.

28. The deflection yoke according to claim 20, wherein a ratio of a thickness at a ⅓ point of the length of the ferrite core starting from an end of the screen side of the ferrite core to the maximum thickness of the end of the neck side of the ferrite core is not greater than 1.0 and not less than 0.8.

29. The deflection yoke according to claim 20, wherein the ferrite core is a divisional ferrite core.

30. The deflection yoke according to claim 20, wherein the cathode ray tube to which the deflection yoke is applied is a monitor.

31. The deflection yoke according to claim 30, wherein a ratio of a maximum inside diameter of the end of the neck side of the ferrite core to the maximum thickness of the ferrite core is not greater than 10.5 and not less than 7.0.

32. The deflection yoke according to claim 20, wherein the cathode ray tube to which the deflection yoke is applied is a color television.

33. The deflection yoke according to claim 32, wherein a ratio of a maximum inside diameter of the end of the neck side of the ferrite core to the maximum thickness of the ferrite core is not greater than 12.5 and not less than 9.0.

34. The deflection yoke according to claim 20, wherein the horizontal deflection coil is a saddle deflection coil.

35. The deflection yoke according to claim 20, wherein the vertical deflection coil is a saddle deflection coil.

36. The deflection yoke according to claim 20, wherein the vertical deflection coil is a toroidal deflection coil.

37. A deflection yoke for a cathode ray tube mounted with a panel, a funnel, an electron gun for emitting electron beams, and a deflection yoke for deflecting the electron beams emitted from the electron gun, the deflection yoke comprising:
a horizontal deflection coil for deflecting the electron beams in the horizontal direction;
a vertical deflection coil for deflecting the electron beams in the vertical direction;
a holder for supporting and at the same time insulating the horizontal and vertical deflection coils; and
a ferrite core for reducing a leakage flux on a return path of magnetic fields generated by the horizontal and vertical deflection coils, where the funnel has a yoke placement portion on which the yoke is mounted, and a cross-section of an inner surface of the yoke placement portion or a cross-section for both the inner and an outer surface of the yoke placement portion gradually changing from a circular shape to a non-circular shape approaching a screen side from a neck side, and a maximum thickness point of the ferrite core ranges from 3 mm to 6 mm in thickness.

38. The deflection yoke according to claim 37, wherein a thickness at the minimum thickness point of the ferrite core is not less than 2 mm.

39. The deflection yoke according to claim 37, wherein a thickness at the maximum thickness point of the ferrite core ranges from 4 mm to 6 mm.

40. The deflection yoke according to claim 37, wherein when a length of the horizontal deflection coil from an end of the neck side to an end of the screen side is Lh, and a length of the ferrite core from an end of a neck side to an end of a screen side is Lf, the end of the neck side of the ferrite core to the end of the screen side of the ferrite core lies within a range from 0.1 Lh to 0.9 Lh of the horizontal deflection coil.

41. The deflection yoke according to claim 37, wherein a length of the ferrite core from end of the neck side to an end of a screen side is not greater than 55 mm and not less than 35 mm.

42. The deflection yoke according to claim 37, wherein a cross-section of the ferrite core is circular or oval.

43. The deflection yoke according to claim 37, wherein a thickness of the end of the neck side of the ferrite core is not greater than 5 mm and not less than 4 mm.

44. The deflection yoke according to claim 37, wherein a ratio of the maximum thickness of the ferrite core to a maximum thickness of the end of the neck side of the ferrite core is not greater than 1.2 and not less than 1.0.

45. The deflection yoke according to claim 37, wherein a ratio of a thickness at a ⅓ point of the length of the ferrite core starting from an end of a screen side of the ferrite core to a maximum thickness of the end of the neck side of the ferrite core is not greater than 1.0 and not less than 0.8.

46. The deflection yoke according to claim 37, wherein the ferrite core is a divisional ferrite core.

47. The deflection yoke according to claim 37, wherein the cathode ray tube to which the deflection yoke is applied is a monitor.

48. The deflection yoke according to claim 47, wherein a ratio of a maximum inside diameter of the end of the neck side of the ferrite core to the maximum thickness of the ferrite core is not greater than 10.5 and not less than 7.0.

49. The deflection yoke according to claim 37, wherein the cathode ray tube to which the deflection yoke is applied is a color television.

50. The deflection yoke according to claim 49, wherein a ratio of a maximum inside diameter of the end of the neck side of the ferrite core to the maximum thickness of the ferrite core is not greater than 12.5 and not less than 9.0.

51. The deflection yoke according to claim 37, wherein the maximum thickness point of the ferrite core exists between the end of the neck side of the ferrite core and ½ Lf, where Lf is a length of the ferrite core.

52. The deflection yoke according to claim 51, wherein a thickness at the maximum thickness point of the ferrite core is not greater than 5.5 mm and not less than 4 mm.

53. The deflection yoke according to claim 37, wherein the horizontal deflection coil is a saddle deflection coil.

54. The deflection yoke according to claim 37, wherein the vertical deflection coil is a saddle deflection coil.

55. The deflection yoke according to claim 37, wherein the vertical deflection coil is a toroidal deflection coil.
